(19) United States
(12) Patent Application Publication
(10) Pub. No.: US 2021/0159678 A1
(43) Pub. Date: May 27, 2021

(54) Insulator Stretcher

(71) Applicant: Hooks & Handlebars, LLC, Broadway, VA (US)

(72) Inventors: James Anthony Wells, III, Broadway, VA (US); Kaleb Daniel Cash, Grottoes, VA (US)

(21) Appl. No.: 16/696,216

(22) Filed: Nov. 26, 2019

(51) Int. Cl. H02G 1/04; B65H 59/12

(52) U.S. Cl. CPC H02G 1/04; B65H 59/12

(57) ABSTRACT

An apparatus to permit both the individual loosening of an electric conductor on a conductor string while on the ground as well as a conveyance from the ground to the bucket of the conductor strings for ease of installation. The apparatus includes a telescoping pole which includes clamps to attach the pole to a top Y-shaped yoke and a bottom Y-shaped yoke. A first conductor string is attached to a first side of the top yoke and a first side of the bottom yoke and a second conductor string is attached to a second side of the top yoke and a second side of the bottom yoke. The first and second conductor strings are comprised of a plurality of electrical conductors. The pole has a top and bottom side. The pole has a hand powered jack attached thereto, which, when actuated, gives a small tolerance intermediate each conductor allowing them to be stretched.

### CROSS-REFERENCE TO RELATED PATENT APPLICATIONS

NONE

### STATEMENT REGARDING FEDERALLY SPONSORED RESEARCH OR DEVELOPMENT

NONE

### BACKGROUND OF THE INVENTION

### Field of Invention

The present disclosure generally relates to apparatus for installing, maintaining, repairing, or dismantling electric cables or lines. More particularly, the present invention is an apparatus for stretching, raising, and installing insulators used for connecting or disconnecting overhead electric power transmission and distribution conductor lines.

### Description of Related Art

Electrical grids deliver vast quantities of electrical energy across increasingly large distances. Modern suspended high voltage and extra high voltage (EHV) transmission line designs provide high power transmission over long distances and transmit bulk quantities of electric power from generating stations to substations. Large transmission lines pass over all types of terrain as power generating stations are often located near their fuel source and located away from heavily populated areas. On arrival at a substation, electric power is stepped down from a transmission level voltage to a distribution level voltage.

Distribution lines distribute power from substations to individual customers in urban and residential areas. Overhead power line structures used for electric power transmission and distribution typically include multiple line conductor wires suspended by poles, towers, or a variety of support structures made of steel, wood, cement, alloys, polymeric materials or the like. All overhead power lines are subject to mechanical tension that imposes resultant force on the support poles and towers. Structures for overhead lines must support the weight of the conductor wires as well as dynamic loads imposed on the lines due to wind, ice accumulation, and vibration. Electrical conductor wires are typically connected to the support structure by a plurality of electrical insulators connected together in series or string fashion to form what is commonly termed an “insulator string” or ‘strand”. The conducting wire is attached to an insulator at one end of the string by means of a strain clamp and the insulator at the other end of the string being attached to the pole tower or other supporting structure. The strings of insulators support the weight of the conductor lines and as such, are under considerable tension. As voltages and distances between towers, poles, and support structures increase, the length and weight of insulator strings increases. Overhead line design also must maintain adequate clearance between energized catenary conductors and the ground to prevent dangerous contact therewith and support the loads imposed on towers by the conductors. Thus, insulator strings must support the weight of the conductors without allowing electric current to flow through the tower to the ground.

For transmission of power across long distances, high voltage transmission is employed. As transmission voltages are increased to ever higher levels, aerial transmission lines must be spaced greater distances from taller transmission line supporting towers and superstructures. Longer lines spanning greater distances increases catenary sag under the force of gravity. Strain insulators are a critical factor is allowing higher voltages to be used in transmission lines such as overhead power lines. They support the weight of the suspended lines without allowing the current to flow through the tower to the ground. To prevent leakage current, insulators must satisfy requirements of sufficient creepage distance along the insulator surface between the two conducting metal parts at each end of the insulator. This means that the insulators strings supporting the transmission lines from the towers must be of greater length.

Insulator strings are made of multiple units of insulator disks, with the number of insulator disks increasing at higher voltages. The number of disks chosen is based on line voltage, lightning-withstand requirements, altitude and environmental factors such as fog, pollution or salt spray. In cases where these conditions are suboptimal, longer insulator strings must be used. Longer insulator strings are heavier. This makes installation and maintenance of heavy strain insulator strings difficult and time-consuming for linemen and line crews.

Insulator material must provide necessary mechanical and electrical characteristics to avoid failure. Insulators are usually made of ceramic materials, porcelain materials, toughened glass, glass-reinforced polymer materials or other non-conducting materials. Porcelain materials provide the necessary mechanical strength, dielectric strength and leakage distance. However, porcelain insulators and insulators generally are often very heavy and brittle making them difficult and expensive to install. Moreover, the dynamic loading on the transmission lines caused by varying weather conditions such as wide variations in temperature, high winds and icing imposes tremendous physical stresses on the line supporting insulators. Strain insulators must be strong enough mechanically to support the full weight of the span of conductor, as well as loads due to ice accumulation and wind. Thus, the insulators must be mechanically robust, in addition to being of high dielectric strength, and consequently are extremely heavy in weight and difficult to install.

Insulators or strain insulators are generally attached to crossarms or crossbars of utility poles and lattice tower structures. “Suspension” and “strain” insulators generally are the same or similar in materials and fabrication. When used in a vertical position with the conductor wire hanging below, insulator strings are termed “suspension” insulators; when used in the horizontal to dead-end a conductor, insulator strings are termed “strain” insulators. A difference between suspension and strain insulator strings is their string strength: strain insulator string strength is generally greater than suspension insulator string strength for purposes of anchoring strain insulators to crossarms with strain clamps and withstanding loads thereon.

Installation and maintenance of strain insulators is a physically laborious and time consuming process because of the large size and heavy weight of insulators. Line crews and linemen must raise heavy, high voltage insulators to great heights for installation on crossarms or crossbars of utility poles and lattice tower structures. Insulators play a fundamental role of supporting high voltage aerial lines and preventing the current from returning to the ground from the conductor wires. Electrical lines are supported by and electrically insulated from towers through the pluralities of electrical insulators connected together in series. Moreover, the insulators must be installed under tension, that is, at the tension they will be attached to the conductor line while work is being done on the line. Large insulator strings are connected at one end to the conductor lines and at the other end to the tower, pole, or support structure. Line anchoring assemblies associated with electrical conductors include insulators, clamping elements, adaptors, and other appurtenances usually employed as parts of such anchoring assemblies for attaching the electrical conductor to the support structure. Line anchoring assemblies of the type with which the novel apparatus disclosed herein may be used ordinarily include one or more series or strings of insulators, the insulators of each string being movably and removably connected together, and each string of insulators being connected at its opposite ends by suitable anchoring assemblies to a support and to an associated electrical conductor line, respectively.

As is well known in the art to which the claimed invention relates, it is very difficult to install or replace damaged strain insulator strings for the reason that the load must be taken off of the conductor and the insulator assembly before the components can be replaced. One of the primary responsibilities of linemen is overhead work on power lines to install, repair and replace insulators.

Therefore it would be useful to provide an apparatus for use to carry, lift, install, maintain and replace strain insulators to reduce the time and physical labor required to install insulators on overhead power lines. The novel apparatus disclosed herein can be used to install new insulators or to remove and replace damaged insulators with a minimum of linemen and without the need for expensive, complex and cumbersome equipment, thereby reducing the overall cost of installation and maintenance by reducing the amount of time and manpower required to carry out the work.

It is an object of this Invention to reduce the time and physical labor required to install insulators on overhead power lines by providing an apparatus used to provide reliable support for securing, carrying, raising and positioning the insulators during their installation and maintenance on overhead power lines and conductors thereby reducing the time, cost and physical labor of the line crew and line men working in proximity of high voltage lines.

Some attempted solutions, such as U.S. Pat. No. 2,654,796 have proposed dead end strain carrier cradles to support insulators during installation, but this solution has not sufficiently addressed the manpower needs of linemen owing to its labor-consuming requirement for multiple operators to handle the device. U.S. Pat. No. 5,377,405 proposes an insulator change-out tool to relieve and reapply strain to insulator strings, but this solution has not sufficiently addressed the needs of linemen for raising insulator strings to overhead support structures on the electrical grid. U.S. Pat. No. 9,461,447 B2 proposes a maintenance tool for insulator strings but this solution has not sufficiently addressed the needs of linemen due to its limited string-handling capacity. W.O. 2012/100595 A1 proposes a line take-up tool and a lifting system for replacing a ceramic rod insulator disk of an insulator string but this has not sufficiently addressed the time-constrained needs of linemen due to its limited string-handling capacity.

In the installation, removal or repair of electric power lines, suspended from their supports by insulator strings, there is a need for an improved strain insulator stretcher that reduces the time and labor required to install insulators on overhead power line supporting structures. An apparatus which is simple in construction, inexpensive to manufacture yet easy to use, rugged and durable, and highly efficient and convenient to reduce the time, manpower and cost required for linemen to tension, stretch, raise and install insulator strings on overhead power lines is a significant improvement over known devices by allowing crews of linemen to efficiently and safely perform installation and maintenance of overhead power line insulators.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF SUMMARY OF THE INVENTION

The present disclosure is in general directed to a novel apparatus for the installation of electrical insulators on overhead electric conductors and particularly to an apparatus for tensioning, carrying, raising, and positioning insulator strings on overhead lines for linemen to install and perform work thereon.

In various exemplary embodiments, the technology described herein provides an improved apparatus for stretching, installing, maintaining, repairing or dismantling strain insulators on electric conductors. The apparatus includes an insulator stretcher for installing strain insulator strings, strands, or stacks on overhead electric conductor lines.

The present invention comprises several embodiments. A first embodiment includes a central cylindrical main body member including two concentric tubular pipe sections comprised of aluminum material and arranged telescopically such that an inner cylindrical tube or pipe is slidingly received within a co-axial outer cylindrical tube or pipe. In other embodiments, the main body member includes two elongate members arranged in longitudinally slidable mounting engagement and locking provisions for allowing longitudinal adjustment, set, and locking of the elongate members at fixed positions therealong the main body of the apparatus. As a general embodiment, the claimed invention is an economical, simple, and durable stretcher apparatus for installing an insulator on an overhead electrical conductor line.

In accordance with one aspect of the present disclosure, the apparatus for stretching and installing insulator strings is provided that includes a central cylindrical main body member that is extensible and adjustable in the longitudinal direction by sliding of the movable tubular pipe sections along a linear axis; each of the two cylindrical concentric tubular pipe sections is provided with at least two pairs of apertures and corresponding locking pins to lock the concentric telescoping tubes or pipes together at distinct increment points of adjustment; the apertures extend through the pipe wall perpendicularly to a central bore of each pipe and are horizontally spaced along a longitudinal axis of each pipe such that the outer pipe apertures are in a position to register in alignment with the inner pipe apertures to form therewith a pair of aligned apertures; a corresponding locking pin removably extends through at least one of the at least two pairs of aligned inner and outer pipe apertures to lock the pipes together in either of an extended length position or in a collapsed length position of the central cylindrical main body member and thereby secure together the inner and outer cylindrical pipes of the main body portion at either of the extended length dimension or the collapsed length dimension corresponding to either of a 115 kV or 230 kV conductor line; a forward assembly includes a laterally extending aluminum end plate positioned and affixed at a distal, forward end of the outer cylindrical pipe of the aluminum main body portion and having at least two bolt-receiving apertures extending through the plate and corresponding bolts; a distal, forward yoke secured to the aluminum end plate by the corresponding bolts and further provided with at least two apertures or eyes extending through the forward yoke at its side corner inner edges, each eye adapted for detachably receiving an end connector fitting of a string of strain insulator units and further including an associated pin to removably secure the insulator string end connector fitting there to the forward yoke; and having at least one aperture located at a distalmost, front vertex of the yoke for receiving a clevis or shackle; a rearward assembly including a proximal, rearward yoke plate bracket adapted to be secured to a proximal, rearward end of the inner cylinder and a proximal, rearward yoke plate having at least one aperture located at a most proximal vertex of the rearward yoke plate and adapted for receiving a clevis or shackle for connecting to a chain; the rearward yoke plate further including at least one pair of apertures, each aperture adapted for detachably receiving an opposite end connector fitting of the insulator string and an associated pin to secure the opposite end connector fitting there to the rearward yoke plate bracket assembly; a carbon plate bolted to the forward assembly aluminum end plate; and a bottle jack welded to the carbon plate, the bottle jack may be hydraulic or work by screw action, in a hydraulic embodiment hydraulic pressure may be provided by a pump either on a baseplate or at a remote location via a pressure hose. The bottle jack may be a 3 ton jack.

In accordance with another aspect of the present disclosure, the inner cylinder is a three-inch Schedule 80 aluminum pipe and the outer cylinder is a five-inch Schedule 80 aluminum pipe. In yet another embodiment adapted for lighter weight usage the inner cylinder is a two and a half inch diameter Schedule 40 aluminum pipe and the outer cylinder is a three-inch Schedule 40 aluminum pipe to obtain advantages of lighter weight due to reduced wall thickness. The invention is adapted to be adjustable along a length dimension for use with various voltage electric lines and line insulators or to accommodate variations in the arrangement of electrical insulator strings.

In summary, the insulator stretcher according to the present claimed invention for the stretching of strain insulator strings during their installation on overhead electric lines may be characterized in one aspect as including an inner telescoping tube including an inner telescoping tube distal end and an inner telescoping tube proximal end, an outer telescoping tube including an outer telescoping tube distal end and an outer telescoping tube proximal end, the inner telescoping tube distal end has a distal end bracket attached thereto, the outer telescoping tube distal end has a biasing plate secured thereto, a bottle jack having a base-plate secured to the biasing plate, the bottle jack including a manually actuated bearing pad which inter-fits on a proximal end bracket cylinder, and the proximal end bracket cylinder is centrally secured on the proximal end bracket, the distal end bracket secures a distal insulator yoke plate thereto, the proximal end bracket secures a proximal insulator yoke plate thereto, the distal insulator yoke plate is triangular, the proximal insulator yoke plate is triangular, the distal insulator yoke plate includes an aperture proximal each of the vertices of the triangle, the proximal insulator yoke plate includes an aperture proximal each of the vertices of the triangle, the distal insulator yoke plate includes a pair of distal yoke plate string fasteners secured to apertures, the distal insulator yoke plate includes a pair of proximal yoke plate string fasteners secured to apertures, a first string of insulator disks are attached intermediate the distal yoke plate string fastener and the proximal yoke plate string fastener, and a second string of insulator disks are attached intermediate the distal yoke plate string fastener and the proximal yoke plate string fastener.

The systems and methods of the present disclosure have been developed in response to problems and needs on the electrical grid overhead power lines that have not yet been fully resolved by currently available systems and methods. As will be readily appreciated from the foregoing, the present invention avoids the disadvantages of currently available apparatus and methods; thus, the apparatus and methods disclosed herein provide a solution to current challenges within the art. These and other features, aspects and advantages in accordance with the claimed invention will become better understood with reference to the following description, appended claims and accompanying drawings.

The above summary is provided merely for purposes of summarizing some example embodiments of the invention so as to provide a basic understanding of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

FIG. 1 is a view of the insulator stretcher apparatus in a generally deployed position, stretching the insulator string.

FIG. 2 is a disassembled view of the apparatus showing outer and inner telescoping tubes in a side-by-side relationship.

FIG. 3 is a front view of the apparatus in a non-deployed position.

FIG. 4 is a side view of the apparatus in a non-deployed position.

FIG. 5 is an exploded perspective view of the apparatus.

FIG. 6 is a view of the forward and rearward assemblies of the apparatus.

FIG. 7 is a view taken from line 6-6 of FIG. 3 showing the apparatus from that position.

FIG. 8 is a partial cut-away view of an alternative embodiment of a bottle jack mounting system removably attachable to the proximal end of the outer telescoping tube.

FIG. 9 is a perspective view of the apparatus providing assembled insulator strings and collar ropes in position for raising or hoisting.

FIG. 10 is a partial view of an alternative embodiment of elongate members of a central main body member of the insulator stretcher apparatus.

FIG. 11 is a partial view of an alternative embodiment of a slidable longitudinal adjustment and locking configuration of elongate members of the insulator stretcher apparatus.

FIG. 12 is a partial view of an alternative embodiment of a handle of the insulator stretcher apparatus.

### DETAILED DESCRIPTION

Embodiments of the claimed invention will be best understood by reference to the accompanying drawings, which are not necessarily to scale, and wherein like reference numbers indicate identical or functionally similar elements. For purposes of clarity, the spaces between the components are not to scale but enlarged to better illustrate the operation of the device. It will be readily understood that the components of the present invention, as generally described and illustrated in the figures herein, could be arranged and designed in a wide variety of different configurations. The claimed invention may be embodied in many different forms and should not be limited to the illustrated embodiments disclosed. Rather, these embodiments are provided so that this disclosure will be thorough and complete, and will fully convey the scope of the claimed invention to those skilled in the art. Thus, the following more detailed description, as represented in the figures, is not intended to limit the scope of the invention as claimed, but is merely representative of presently preferred embodiments of the invention.

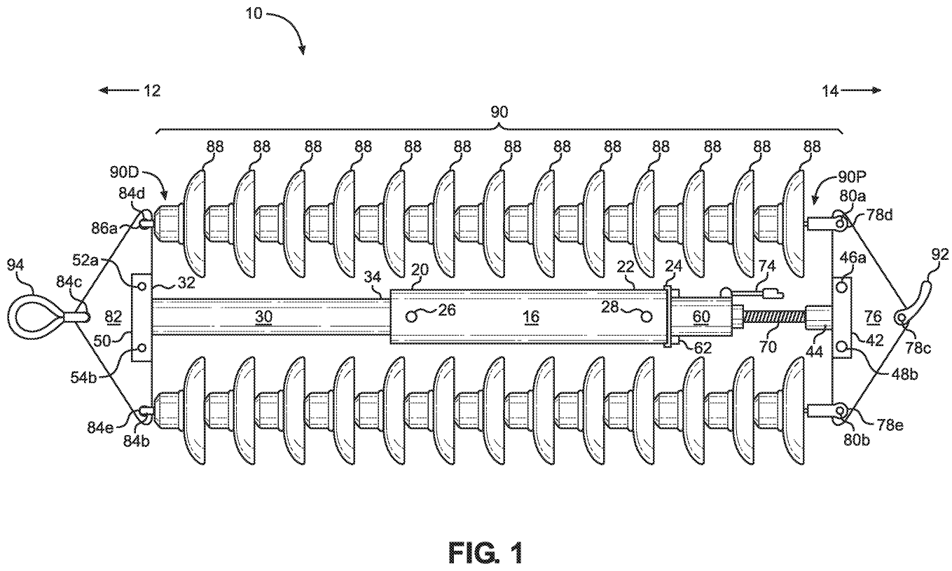

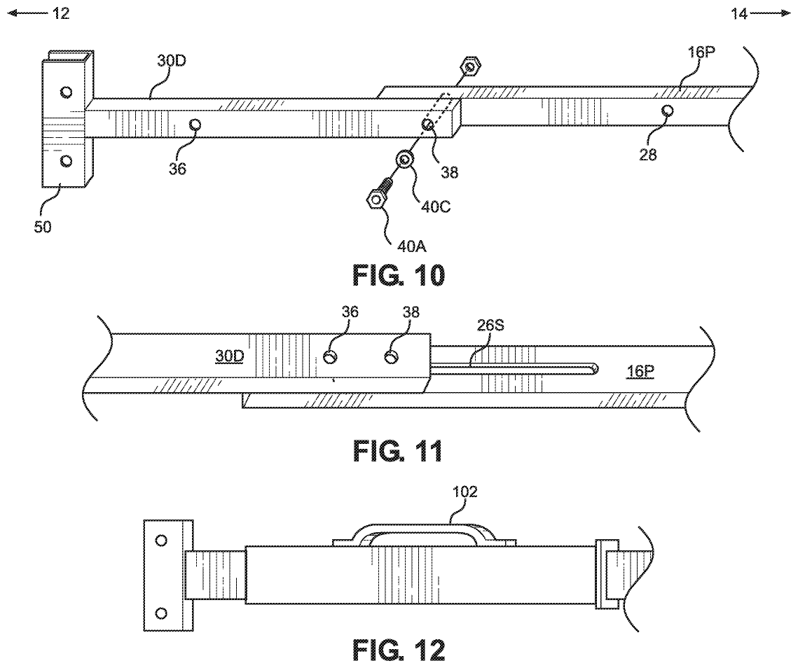

FIGS. 1-12 illustrate schematically an insulator stretcher apparatus. In the arrangement described herein, the insulator stretcher apparatus having a proximal end and a distal end is oriented such that when a plurality of insulator disks connected together in series, termed “strings” or “strands”, such that strings of insulator disks are mounted between a proximal end bracket and a distal end bracket, a bottle jack is affixed to the proximal end and the proximal end is the end manipulated by a user to stretch the apparatus and the attached insulator strings. The insulator strings are mounted in parallel alignment with a central main body member of the apparatus which is also parallel with a longitudinal centerline axis of the apparatus thereby allowing the user to adjust the longitudinal extensibility of the apparatus and stretch the insulator strings for installing on overhead conductor wires of power lines.

Referring specifically to FIG. 1, a view of the apparatus 10 is shown in a generally deployed position, which is the position in which a string 90 or a pair of strings including a first string 90, and a second string 90 of insulator disks 88 will be stretched, aligned, and raised to installation position on a crossarm or support structure. The apparatus 10 has an apparatus distal end 12 and an apparatus proximal end 14.

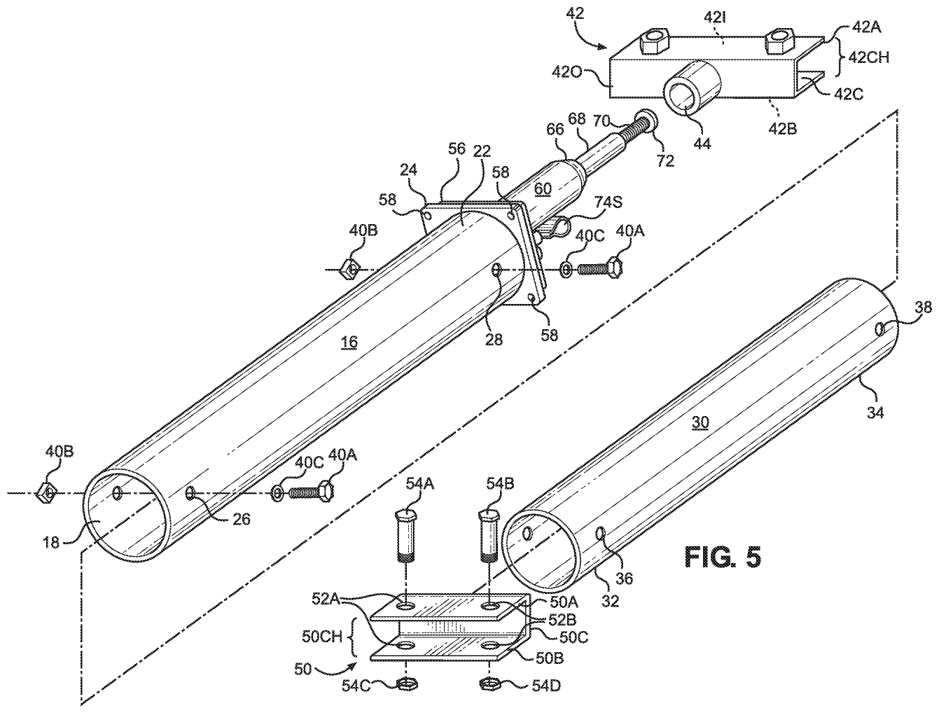

The apparatus includes an outer telescoping tube 16. The outer telescoping tube 16 includes an outer telescoping tube distal end 20 and an outer telescoping tube proximal end 22. The outer telescoping tube 16 includes a proximal end 22 forward assembly as will be described further herein. The outer telescoping tube may preferably be a hollow cylindrical tube, however it could be of another geometrical configuration including but not limited to, a hollow rectangular tube or a hollow hexagonal tube. It is understood that other polygonal shapes are contemplated while remaining within the scope of the present disclosure or appended claims, as will be appreciated by those skilled in the art, along with other benefits and advantages of the present invention. As best seen in FIG. 5, the outer telescoping tube 16 includes a cylindrical opening on the distal end 20. A biasing plate 24 is attached by welding or other means to the outer telescoping tube proximal end 22.

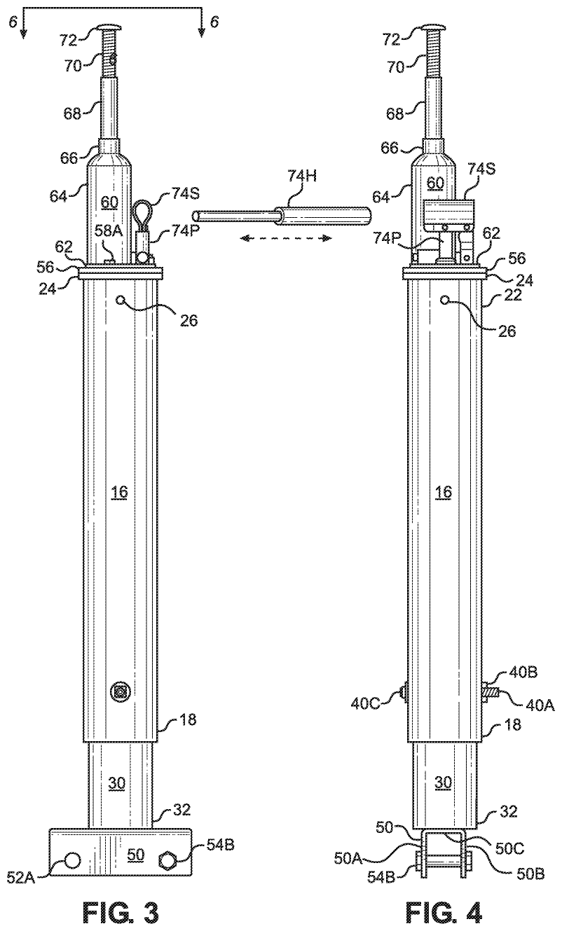

The apparatus 10 further includes an inner telescoping tube 30. The inner telescoping tube 30 includes an inner telescoping tube distal end 32 and an inner telescoping tube proximal end 34. The inner telescoping tube 30 may preferably be a hollow cylindrical tube which is dimensioned such that it would be slidingly received within the outer telescoping tube 16. In embodiments in which the outer telescoping tube 16 is not cylindrical, then the inner telescoping tube 30 would be provided with the same geometrical configuration as the outer telescoping tube 16. In alternative embodiments the central main body member includes a proximal elongate mounting member 16P employed in combination with a distal elongate sliding member 30D for connection with locking members which are mechanical fasteners 40A, 40B, and 40C as shown in FIGS. 3-5 and 10 for locking the elongate members 16P, 30D at predetermined positions corresponding to registration apertures 26, 28 of proximal elongate mounting member 16P and 36, 38 of distal elongate sliding member 30D respectively along the length thereof as shown in FIGS. 3-5, 10 and 11. As depicted in FIG. 11, not necessarily to scale, the employment of a slot 26S in proximal elongate mounting member 16P allows longitudinal adjustment of the central main body of the apparatus to any desired position by the sliding of the distal elongate sliding member 30D along a surface of the proximal elongate mounting member 16P and tightening of the mechanical fasteners 40A, 40B, and 40C thereby locking the members 16P, 30D at the desired position.

As shown in FIG. 12, in some embodiments outer surface of outer telescoping tube 16 is providing with a handle 102 fastened or joined to the outer surface by means including, but not limited to, welding, riveting, or mechanical fastening, thereby providing a sturdy structure and thereby allowing a lineman to handle and guide the apparatus in a convenient manner. The handle 102 may be fabricated of aluminum or non-conductive materials or materials encased by non-conductive materials, the selection of which would be within the ordinary skill of a worker in the art.

In a preferred embodiment, the inner and outer telescoping tubes are fabricated of aluminum. Other materials are available that would be suitable for alternative embodiments of the subject matter of the disclosure. Examples include, but are not limited to, any suitable durable material including non-conductive materials such as plastic, resin, thermoplastics, rubber materials, wood, polyvinyl chloride (PVC), polyethylene, high density polyethylene, cross-linked polyethylene, fiberglass, or carbon fiber; and metallic materials such as stainless steel, titanium, metal composites or alloy, any combinations thereof, or any other suitable materials that provide uniform strength, stress distribution throughout the structure and have material properties that would be suitable for alternative embodiments of the subject matter of the disclosure. These materials are readily available and those in the art are familiar with working with such materials. The selection of suitable materials based on known properties of conductivity, specific weight, durability, toughness and strength would be within the ability of a person skilled in the art. Those in the art will understand that any suitable material, now known or hereinafter developed, may be used in forming the portions of the apparatus described herein. Those of skill in the art will understand that a number of variations may be made in the disclosed embodiments, all without departing from the scope of the invention, which is defined solely by the appended claims.

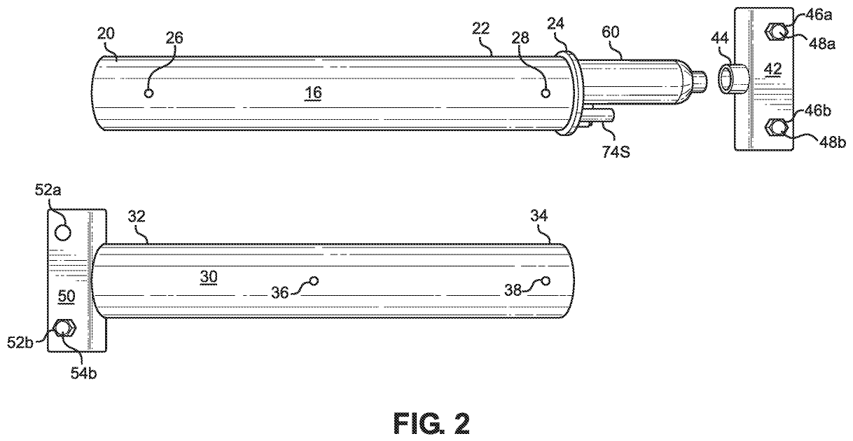

The inner telescoping tube 30 includes a distal end 32 rearward assembly as will be described further herein. As best depicted in FIGS. 2 and 5, a distal end bracket 50 bisects the inner telescoping tube 30 distal end 32. In a preferred embodiment the distal end bracket 50 is U-shaped; however in alternative embodiments the bracket may have other shapes. The term “bracket” is used in a functional sense indicating a generally angle-shaped structural support member formed as a projection extending from a surface as for an affixably securable support. The preferred embodiment employs a bracket. Other structures are available for alternative embodiments that can include, but are not limited to, shelves, corbels, clamps, clasps, braces, bands, slots, mechanical fasteners, and any suitable structures that will remain dimensionally stable and withstand the stresses of tension to which the apparatus is subjected. The portions of the distal end bracket 50 which are in communication with the inner telescoping tube distal end 32 are secured thereto preferably by welding although any appropriate securing means may be employed. The orientation and configuration of the distal end bracket 50 can best be seen in FIG. 5. The distal end bracket 50 includes two parallel sidewalls 50a, 50b connected by a bottom element 50c. The bottom element 50c of the distal end bracket 50 is the element which is affixed to the inner telescoping tube distal end 32. The distal end bracket 50 forms a channel 50C, and this channel 50C faces outward from the inner telescoping tube distal end 32. The distal end bracket 50 will be described in further detail in the description of FIG. 4 and FIG. 5.

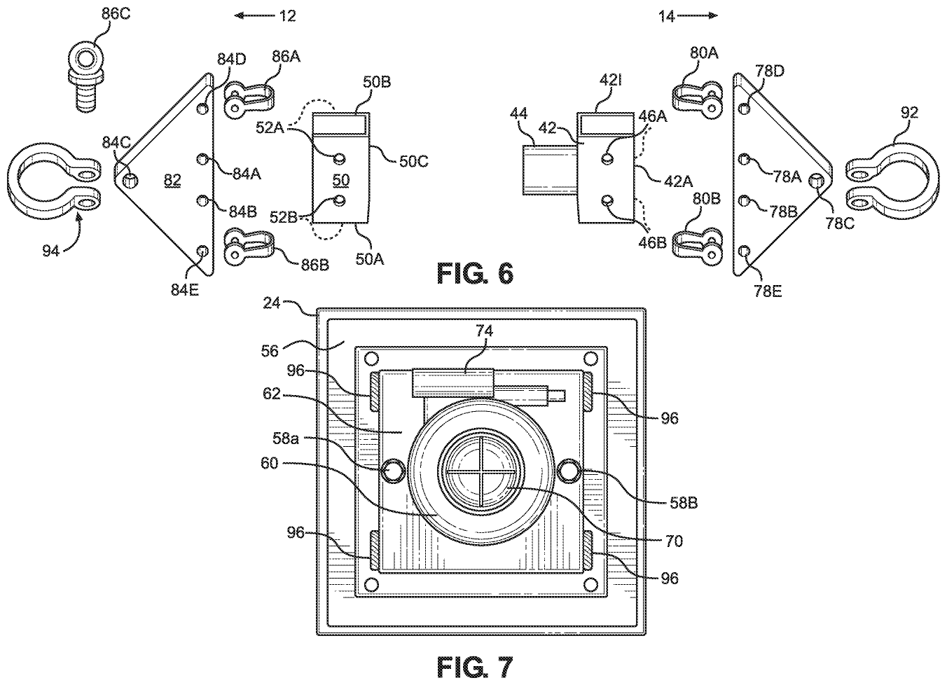

A distal insulator yoke plate 82 is generally triangular and is secured in the distal end bracket 50 by mechanical fasteners 54a, 54b as seen best in FIG. 6. The term “mechanical fasteners” is used in a functional sense indicating devices generally used to mechanically join or fix two or more objects together. Other fasteners that would be suitable for alternative embodiments can be, but is not limited to, screws, bolts, pins, and any other fasteners that are available that have the material properties that would be suitable for alternative embodiments of the of the subject matter of the disclosure. The mechanical fasteners 54a, 54b pass through linearly aligned distal end bracket 50 apertures 52a, 52b located on the two parallel sidewalls 50a, 50b of the distal end bracket 50. As shown in FIG. 6, the distal insulator yoke plate 82 has a pair of apertures 84a, 84b in alignment with the distal end bracket 50 apertures 52a, 52b allowing the distal insulator yoke plate 82 to be securely affixed to the distal end bracket 50. Preferably, distal mechanical nuts 54c, 54d are rotatably tightened about the end portion of the mechanical fasteners 54a, 54b as best seen in FIG. 5.

The distal insulator yoke plate 82 is a solid planar triangular element. The distal insulator yoke plate 82 includes a further three apertures 84c, 84d, 84e; each one located close to the interior angles of the triangularly shaped distal yoke plate 82. Each of the three apertures 84c, 84d, 84e will have a corresponding fastener 86a, 86b, 86c associated therewith. Fastener 86c secures a distal connector shackle 94. The other two fasteners 86a and 86b will secure a distal end of a pair of insulator strings 90, 90.

As shown in FIGS. 3, 4, 7 and 8, a biasing plate 24 is welded or secured by other known means to the proximal end 22, covering the cylindrical opening 18 of the proximal end 22 of outer telescoping tube 16. The biasing plate 24 is a flat plate which is employed as a stand for a lifting mechanism such as a base plate 62 of a bottle jack 60. The bottle jack 60 includes the base plate 62, a jack body 64, a neck 66, a lifting ram 68, a threaded, extendable portion of a shaft 70, and a platform bearing pad 72. The lifting ram 68 and the threaded, extendable portion of the shaft 70 of the bottle jack shaft 60 are hydraulically moved by the actuation of a manual lever or handle 74H which engages the handle socket 74S and by moving the manual lever or handle 74H up and down, a piston pump 74P causes the movement of the lifting ram 68.

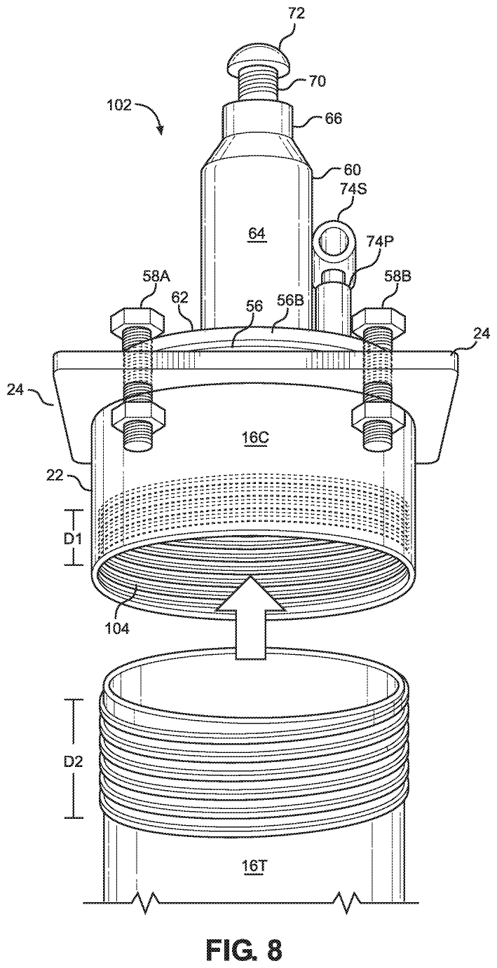

A carbon plate 56 is placed intermediate the biasing plate 24 and the base plate 62 of the bottle jack 60. A pair of mechanical fasteners 58a, 58b are received in and will pass through a pair of off-set apertures 62a, 62b which would be made in the base plate 62 of the bottle jack 60, and further through aligned apertures 56a, 56b placed in the carbon plate 56, and then further through aligned apertures 24a, 24b located on the biasing plate 24. The bottom threaded elements of the mechanical fasteners 58a, 58b will be in the interior of the proximal end of the outer telescoping tube 16. A further embodiment contemplates that the proximal end 22 of the outer telescoping tube 16 may be threaded at distance D1 as shown in FIG. 8 (not to scale). Removable cap 16C includes a threaded portion formed having threads which may be internal female threads 104 formed along an inner surface of the removable cap 16C for secure mating engagement with corresponding external male threads formed on an outer surface of a threaded outer telescoping tube 16T at a corresponding distance D2. This would permit a portion of the proximal end 22 of the outer telescoping tube 16 to be rotatably removable to allow an easy placement of nuts or other means to tighten the mechanical fasteners 58a, 58b. Additionally, the mechanical fasteners 58a, 58b may be chosen from the group of mechanical fasteners which have integral tightening mechanisms which would pass through the apertures discussed above and deploy after the mechanical fasteners pass through the biasing plate 24. Those having ordinary skill in the art will understand that the female threads may be provided on the external surface of the threaded outer telescoping tube 16T and the male threads provided on the inner surface of the removable cap 16C; and that a number of variations may be made in the disclosed embodiments, all without departing from the scope of the invention, which is defined solely in the appended claims. The term “threads” is used in a functional sense indicating generally helical structures arranged annularly along, within, or wrapped around a cylinder or cylindrical surface and used to convert between rotational and linear movement or force. Those having ordinary skill in the art will understand that other mating components suitable for alternative embodiments providing convenient assembling and disassembling or engagement and disengagement of the apparatus include, but are not limited to, screws, bolts, pins, tabs and slots, interlocking ridges, grooves and channels, pairs of springs vertically spaced or annularly spaced, or runners and springs, and any other suitable mutually complementing shapes and structural elements that have the material properties that would be suitable for alternative embodiments of the subject matter of the disclosure are contemplated within the scope of the subject matter of the present disclosure.

As shown in FIGS. 2, 5 and 6, a proximal end bracket 42 which is a formed as a U-shaped bracket includes two parallel sidewalls 42a, 42b connected by a bottom element 42c. The bottom element of the U-shaped proximal end bracket 42 has an interior channel side 42I and an opposite side 42O. In the centroid of the opposite side 42O is a hollow cylindrical element 44 which is affixed to the opposite side 42O of the U-shaped proximal end bracket 42.

The proximal end bracket 42 has at least two mechanical elements which each perform a specific function. The first function is to receive the end portion of platform bearing pad 72 of the threaded, extendable portion of the shaft 70 within the hollow cylindrical element 44. This permits the force of the bottle jack to be distributed between the biasing plate 24 and the end portion or platform bearing pad 72 of the threaded, extendable portion of the shaft 70. By manually actuating the bottle jack 60, the threaded, extendable portion of the shaft 70 moves away from the body 64 and is positioned in the proximal end bracket 42 cylindrical element 44, as further discussed hereinafter with respect to operation of the apparatus 10.

The term “jack” is used in a functional sense indicating a lifting mechanism or a machine, usually portable, for lifting heavy weights by force acting from below. Other devices are available for alternative embodiments can include, but are not limited to, whiskey jacks, jackscrews, mechanical jacks employing a screw thread, hydraulic jacks, hydraulic presses, pneumatic jacks, mechanical screws, tensioning mechanisms, winches, come-alongs and “take-ups”.

The second function is to connect the proximal insulator yoke plate 76 to the channel side of the U-shape of the proximal end bracket 42. The proximal insulator yoke plate 76 is a solid planar triangular element with a plurality of apertures. Two of the apertures are dimensioned such that when the proximal insulator yoke plate 76 is placed in the channel located on the proximal end bracket 42 the mechanical fasteners pass through the first sidewall 42a, pass through the apertures located on the proximal insulator yoke plate 76, then through the second sidewall 42b where they are tightened down by proximal mating fasteners 48a, 48b.

The proximal end bracket 42 U-shape forms a channel, and this channel faces outward. The two parallel sidewalls each have proximal end bracket apertures 46a, 46b which receive mechanical fasteners therein. This channel holds the proximal insulator yoke plate 76 which is secured in the channel by the mechanical fasteners 48a, 48b.

The proximal insulator yoke plate 76 is generally triangular and is secured in the proximal end bracket by mechanical fasteners 48a, 48b as best seen in FIG. 2. As best depicted in FIG. 6, the mechanical fasteners 48a, 48b pass through distal end bracket apertures 46a, 46b which are aligned in the two parallel sidewalls of the U-shaped proximal end bracket 42. The proximal insulator yoke plate 76 has a pair of apertures 78a, 78b in alignment with the proximal end bracket apertures 46a, 46b permitting the proximal insulator yoke plate 76 to be securely affixed to the proximal end bracket 42.

The proximal insulator yoke plate 76 is a solid triangular element. The proximal insulator yoke plate 76 includes a further three apertures 78c, 78d, 78e; each one located close to the interior angles of the triangularly shaped proximal yoke plate 76. Each of the three apertures 78c, 78d, 78e will have a corresponding fastener 80a, 80b, 80c associated therewith. Fastener 80c secures a proximal connector shackle 92 in aperture 78c located in the proximal-most vertex of the yoke plate, that is, the vertex of the angle located opposite the hypotenuse of the proximal insulator yoke plate 76. The other two fasteners 80d and 80e will secure the proximal ends of the first string 90 and the second string 90 of insulator disks 88.

The distal yoke plate 82 and the proximal yoke plate 76 are both connected to a string 90 or strings 90, 90 of electrical insulator “bells” or disks 88 connected together in series to form the string 90 or strings 90, 90. Each individual electrical insulator disk 88 is connected to the adjacent electrical insulator disk 88 by a ball and socket arrangement or other conventional means (not shown).

FIG. 1 shows, not necessarily to scale, the apparatus 10 assembled in a configuration which permits two strings 90, 90 of electrical insulators 88 wherein each string 90 of the insulators 88 is composed of a certain number of electrical insulators 88 corresponding to a particular voltage conductor.

This is achieved by having the apparatus 10 in its most elongated or extended position where a locking fastener is placed through outer telescoping tube distal end locking aperture 26 into the inner telescoping tube proximal end first locking aperture 28. This is the position shown in FIG. 1 where two strings 90, 90 of electrical insulators is composed of 13 electrical insulator disks 88.

This configuration insulates high voltage transmission lines in which roughly 230 kilo volts of electricity are traveling where such high voltage lines are suspended from utility poles and towers of various heights. Alternatively, the apparatus 10 may be shortened by the inner telescoping tube 30 being linearly moved into the outer telescoping tube 16, and secured thereto by fastener 40a passing through aperture 26 which is also known as outer telescoping tube distal end locking aperture 26, into aperture 38 also known as second inner telescoping tube locking aperture 38. In this position, each string 90, 90 of insulators would be composed of eight electrical insulator disks 88 (not shown). Eight electrical insulator disks would be employed to insulate transmission lines in which roughly 115 kilovolts of electricity are traveling. A string of thirteen electrical insulator disks would be employed to insulate transmission lines in which roughly 230 kilovolts of electricity are traveling.

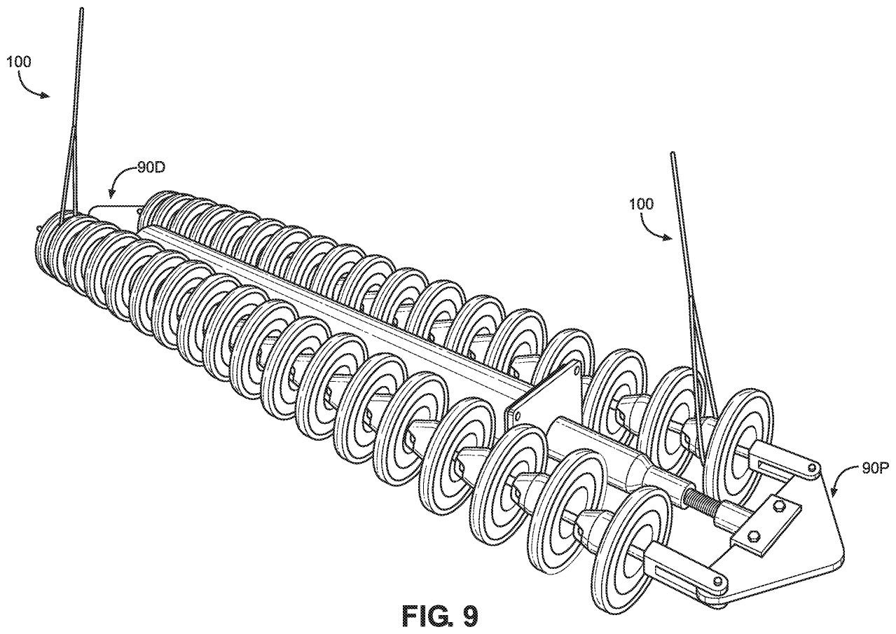

The apparatus functions as follows. The telescoping tubes 16, 30 are set at a preferred distance for a string of eight electrical insulator disks or for a string of 13 electrical insulator disks. In this example, we will set the telescoping tubes 16, 30 to receive a pair of insulator strings 90, 90 including a first string 90, and a second string 90, each composed of 13 insulator disks 88. In this example, locking pin 40A is set and secured with locking fastener gasket 40C and locking nut 40B in locking aperture 26 of outer telescoping tube 16 and locking aperture 28 of inner telescoping tube 30 and fastened therein for a 13-disk insulator string for installation of a 230 kV conductor. The locking pin 40A would be set in outer telescoping tube 16 locking aperture 28 and inner telescoping tube 30 locking aperture 28 for an eight-disk insulator string for installing a 115 kV conductor wire. The apparatus 10 is placed between a pair of assembled strings of insulators. The distal yoke plate 82 hypotenuse side is placed and received between the two parallel sidewalls 50a, 50b within of the U-shaped distal yoke plate bracket 50 interior channel side 42I. Each string 90 has a proximal end 90p and a distal end 90d. The first string distal end 90d will be attached by a fastener 86b to the distal insulator yoke plate 82. The first string proximal end 90p will be attached by a fastener 80b to the proximal insulator yoke plate 76. The second string distal end 90d will be attached by a fastener 86b to the distal insulator yoke plate 82. The second string proximal end 90p will be attached by a fastener 80b to the proximal insulator yoke plate 76. The bottle jack 60 bearing pad 72 is placed in co-axial alignment with bore of hollow cylindrical element 44 while a user actuates jack handle 74H within handle socket 74S such that piston pump 74P causes extension of lifting ram 68 thereby applying force to proximal bracket 76 sufficient to stretch insulator strings 90, 90 until the strings are under sufficient tension for the user to “weather the glass”, as is colloquially known in the art, that is, to align or position the disks 88 uniformly facing downwardly to thereby prevent water incursion into pockets, skirts or ridges located on the underside of the disks 88 in order to prevent freezing damage to the insulator disks 88. After weathering the glass, the jack piston is actuated again 74P via handle 74H to apply sufficient force to stretch the insulator string 90 or strings 90, 90 to the tension at which they are connected to the conductor wire and anchored to the crossarm. Collar ropes or lines are placed and wrapped around the insulator string as best depicted in FIG. 9, and the apparatus 10 with attached strings 90, 90 is raised or hoisted to the support structure for installation of the strings. During installation, the jack piston 74P may be further actuated to increase tension on the insulator string 90 as required for purposes of anchoring the string end clamps to the crossarm of the utility tower or support structure.

Removal of the insulator strings from the apparatus is accomplished after installation by removing fasteners 84d, 84e from distal yoke plate bracket 50 while the ropes 100, 100 are attached, the bottle jack handle is used to loosen or open the release valve to thereby release pressure from the jack and remove apparatus 10 from the strings 90, 90. The ropes 100, 100 are removed and may be secured around outer tube. The proximal end yoke plate bracket 42 is removed from the proximal yoke plate 76 and the apparatus 10 is lowered to the ground.

Although the present invention has been described in considerable detail with reference to certain preferred versions thereof, other versions are possible. Therefore, the spirit and scope of the appended claims should not be limited to the description of the preferred or exemplary embodiments herein. A substantive encapsulation of the invention has been provided using specific terms and drawings. Such illustrations are for representative purposes only and are not intended to capture all iterations and variations of the invention.

It will be appreciated that the above description relates to a specific embodiment of the invention, provided by way of example only. A number of variations are possible, and would be obvious to those of ordinary skill in the art. Such obvious variations are within the scope of the invention as defined and claimed, whether or not expressly recited. Although specific arrangements are shown in the exemplary embodiment, any suitable structures, attachments or mechanisms can be employed to perform the function recited herein; neither the present disclosure nor the appended claims are limited to the specific arrangements or embodiments shown in the Drawings. It is intended that equivalents of the disclosed exemplary embodiments and methods shall fall within the scope of the present disclosure or appended claims. It is intended that the disclosed exemplary embodiments and methods, and equivalents thereof, may be modified while remaining within the scope of the present disclosure or appended claims.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. The embodiment was chosen and described in order to best explain the principles of the invention and its practical application, and to thereby enable others skilled in the art to best utilize the invention and various embodiments with various modifications as are suited to the particular use contemplated. It is understood that various omissions, additions, or substitutions of equivalents are contemplated as circumstances may suggest or render expedient without departing from the scope of the disclosure, but is intended to cover the application or implementation without departing from the spirit or scope of the claims of the present invention. The terms “including” and “having” as used in the specification and claims shall have the same meaning as the term “comprising.”

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

We claim:

1. An insulator stretcher for the stretching of strain insulator strings during their installation on overhead electric lines comprising:
an inner telescoping tube including an inner telescoping tube distal end and an inner telescoping tube proximal end,
an outer telescoping tube including an outer telescoping tube distal end and an outer telescoping tube proximal end,
said inner telescoping tube distal end has a distal end bracket attached thereto,
said outer telescoping tube distal end has a biasing plate secured thereto,
a bottle jack having a base-plate secured to said biasing plate said bottle jack including a manually actuated bearing pad which inter-fits on a proximal end bracket cylinder, and said proximal end bracket cylinder is centrally secured on said proximal end bracket,
said distal end bracket secures a distal insulator yoke plate thereto,
said proximal end bracket secures a proximal insulator yoke plate thereto,
said distal insulator yoke plate is triangular,
said proximal insulator yoke plate is triangular,
said distal insulator yoke plate includes an aperture proximal each of the vertices of the triangular distal insulator yoke plate,
said proximal insulator yoke plate includes an aperture proximal each of the vertices of the triangular proximal insulator yoke plate,
said distal insulator yoke plate includes a pair of distal yoke plate string fasteners secured to apertures
said distal insulator yoke plate includes a pair of proximal yoke plate string fasteners secured to apertures,
a first string of insulator disks are attached intermediate said distal yoke plate string fastener and said proximal yoke plate string fastener,
and a second string of insulator disks are attached intermediate said distal yoke plate string fastener and said proximal yoke plate string fastener.

2. An insulator stretcher for the stretching of strain insulator strings during their installation on overhead electric lines as claimed in claim 1 wherein,
said distal insulator yoke plate said apertures includes a distal hoist shackle aperture securing a distal hoist shackle,
and said proximal yoke plate said apertures includes a proximal hoist shackle aperture securing a proximal hoist shackle,
wherein said distal hoist shackle connects to a utility pole and said proximal hoist shackle connects to a conductor wire being installed.

3. An insulator stretcher for the stretching of strain insulator strings during their installation on overhead electric lines as claimed in claim 2 wherein,
said distal end bracket includes 2 pairs of apertures,
and said distal insulator yoke plate further includes a pair of apertures, whereby a of pair mechanical fasteners secure said distal end bracket to the distal insulator yoke plate.

4. An insulator stretcher for the stretching of strain insulator strings during their installation on overhead electric lines as claimed in claim 3 wherein,
said proximal end bracket includes 2 pairs of apertures,
and said distal insulator yoke plate further includes a pair of apertures, whereby a of pair mechanical fasteners secure the proximal end bracket to the distal insulator yoke plate.

5. An insulator stretcher for the stretching of strain insulator strings during their installation on overhead electric lines as claimed in claim 4 wherein,
a carbon plate is secured intermediate said base plate of said bottle jack and said biasing plate.

6. An insulator stretcher for the stretching of strain insulator strings during their installation on overhead electric lines as claimed in claim 5 wherein,
said biasing plate is welded to said outer telescoping tube proximal end.

7. An insulator stretcher for the stretching of strain insulator strings during their installation on overhead electric lines as claimed in claim 6 wherein,
said biasing plate is comprised of aluminum.

8. An insulator stretcher for the stretching of strain insulator strings during their installation on overhead electric lines as claimed in claim 7 wherein,
said bottle jack includes an actuation handle, a handle socket and a piston pump immediately adjacent said base-plate, whereby when said bottle jack is manually actuated by said actuation handle, said outer telescoping tube and said inner telescoping tube move said distal insulator yoke plate and said proximal yoke plate are moved apart, thus causing said first string of insulator disks and said second string of insulator disks to impart tension on the connector fittings between each of the insulator disks, then hoisting both strings to the electrical lines where they are installed, and by loosening said bottle jack release valve and reversing direction of the bottle jack, said outer telescoping tube and said inner telescoping tube are moved together, and said insulator stretcher can be lowered back to the ground and used again.

9. An insulator stretcher for the stretching of strain insulator strings during their installation on overhead electric lines as claimed in claim 8 wherein said outer telescoping tube includes a distal end locking aperture.

10. An insulator stretcher for the stretching of strain insulator strings during their installation on overhead electric lines as claimed in claim 9 wherein said outer telescoping tube includes a proximal end locking aperture.

11. An insulator stretcher for the stretching of strain insulator strings during their installation on overhead electric as claimed in claim 10 wherein said outer telescoping tube includes a removable cap.

12. An insulator stretcher for the stretching of strain insulator strings during their installation on overhead electric as claimed in claim 10 wherein said outer telescoping tube includes a handle.
